(19) United States
(12) Patent Application Publication
(10) Pub. No.: US 2006/0230165 A1
(43) Pub. Date: Oct. 12, 2006

(54) Method and apparatus for provisioning network infrastructure

(76) Inventors: Vincent J. Zimmer, Federal Way, WA (US); Michael A. Rothman, Puyallup, WA (US)

Correspondence Address: KACVINSKY LLC, 4500 BROOKTREE ROAD, SUITE 102, WEXFORD, PA, 15090, US

(21) Appl. No.: 11/089,634

(22) Filed: Mar. 25, 2005

(51) Int. Cl. G06F 15/16

(52) U.S. Cl. 709/230

(57) ABSTRACT

A system, apparatus, method and article to provision network infrastructure are described. The apparatus may include a network processing node to receive provisioning information from a provisioning node. The network processing node may include an identity to associate provisioning information with the network processing node, a boot loader to request provisioning information from the provisioning node, and a certificate associated with the provisioning node to authenticate the network processing node. Other embodiments are described and claimed.

### BACKGROUND

Initializing or provisioning network infrastructure, such as a network platform, typically involves installing an operating system (OS) onto the platform. In some cases, the OS may be embedded in the flash memory of the network platform. This approach is limited by the fixed configuration and proprietary characteristics of the OS flashed into the platform. In addition, this approach consumes flash memory, which is an expensive resource.

Alternatively, the platform may be initialized or provisioned using rudimentary boot firmware to load or install an OS. In general, the boot firmware is intended to enable hardware to operate as a system after booting by loading and installing the OS. This approach is limited by a lack of integral security and the inability to load across wide-area networks.

Accordingly, there may be a need for improved techniques for provisioning a network infrastructure to promote interoperability of firmware building blocks and to allow equipment manufacturers and vendors to add platform innovation around an open framework.

### BRIEF DESCRIPTION OF THE DRAWINGS

FIG. 1 illustrates one embodiment of a system.

FIG. 2 illustrates one embodiment of a node.

FIG. 3 illustrates one embodiment of a system.

FIG. 4 illustrates one embodiment of programming logic.

FIG. 5 illustrates one embodiment of programming logic.

FIG. 6 illustrates one embodiment of a framework.

### DETAILED DESCRIPTION

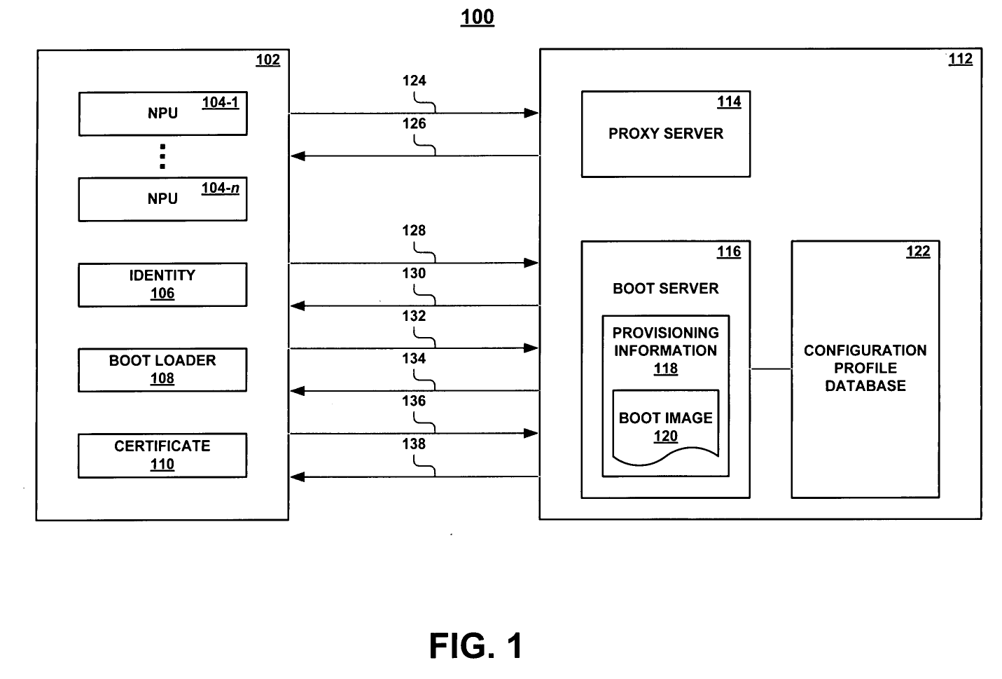

FIG. 1 illustrates one embodiment of a system. FIG. 1 illustrates a block diagram of a system 100. The system 100 may comprise a communication system having multiple nodes. A node generally may comprise any physical or logical entity for communicating information in the system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

A node may comprise any physical or logical entity having a unique address in system 100. The unique address may comprise, for example, a network address such as an Internet Protocol (IP) address, a device address such as a Media Access Control (MAC) address, and so forth. The embodiments are not limited in this context.

The nodes of the system 100 may comprise or form part of a network, such as a Local Area Network (LAN), a Metropolitan Area Network (MAN), a Wide Area Network (WAN), a Wireless LAN (WLAN), the Internet, the World Wide Web, a telephony network (e.g., analog, digital, wired, wireless, PSTN, ISDN, or xDSL), a radio network, a television network, a cable network, a satellite network, and/or any other wired or wireless communications network configured to carry data. The network may include one or more elements, such as, for example, intermediate nodes, proxy servers, firewalls, routers, switches, hubs, adapters, sockets, and wired or wireless data pathways, configured to direct and/or deliver data to other networks. The embodiments are not limited in this context.

The nodes of the system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks. The embodiments are not limited in this context.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may comprise a packet network communicating information in accordance with one or more packet protocols, such as one or more Internet protocols, such as the Transport Control Protocol (TCP) and Internet Protocol (IP), TCP/IP, X.25, Hypertext Transfer Protocol (HTTP), and User Datagram Protocol (UDP). In another example, system 100 may communicate packets using a medium access control protocol such as Carrier-Sense Multiple Access with Collision Detection (CSMA/CD), as defined by one or more IEEE 802 Ethernet standards. In yet another example, system 100 may communicate packets in accordance with one or more Asynchronous Transfer Mode (ATM) protocols, Frame Relay, Systems Network Architecture (SNA), and so forth. The embodiments are not limited in this context.

As shown in FIG. 1, the system 100 may comprise a network processing node 102. In various embodiments, the network processing node 102 may be arranged to operate as a network forwarding device. A network forwarding device generally may comprise any type of network device arranged to send and receive packets in a network. Examples of a network forwarding device include a computer, server, appliance, switch, switch blade, router, bridge, gateway, hub, wireless access point, base station, radio network controller (RNC), mobile subscriber center (MSC), and so forth. The embodiments are not limited in this context.

In one embodiment, the processing node 102 may be arranged to operate in accordance with one or more MAC protocols, such as from the IEEE 802.3 series of Ethernet protocols, for example. The processing node 102 may be implemented as a high bandwidth switch, such as a Fast Ethernet switch operating at 100 megabits per second (Mbps), a Gigabit Ethernet switch operating at 1000 Mbps or 10 Gigabits per second (Gbps), and so forth. The embodiments are not limited in this context.

In various embodiments, the network processing node 102 may comprise network processing units 104-1-n, where n represents any positive integer. Each network processing unit 104-1-n may comprise, for example, a network processor implemented as an XScale® based architecture by Intel® Corporation of Santa Clara, Calif. In various implementations, a network processor may comprise a processor designed specifically for packet processing, a core element in high-speed communications routers and switches. Similar in some ways to a general purpose processor, a network processor is a programmable chip. The instruction set for the network processor, however, has been optimized to support the operations needed in networking, particularly for packet processing. Network processors therefore provide the programmability of a general purpose processor, with the speed of a dedicated custom hardware, such as an Application Specific Integrated Circuit (ASIC).

In other embodiments, the processing units 104-1-n may comprise any suitable type of processor such as a chip multiprocessor (CMP), a general purpose processor, a dedicated processor, such as a controller, micro-controller, embedded processor, a digital signal processor (DSP), a field programmable gate array (FPGA), a programmable logic device (PLD), a network processor, an I/O processor, and so forth. The embodiments are not limited in this context.

In various implementations, the processing node 102 may be arranged to perform various processing operations. Processing operations may generally refer to one or more operations, such as generating, managing, communicating, sending, receiving, storing forwarding, accessing, reading, writing, manipulating, encoding, decoding, compressing, decompressing, encrypting, filtering, streaming or other processing of information. The embodiments are not limited in this context.

In various embodiments, the processing node 102 may require provisioning or repurposing to enable the processing node 102 to perform various processing operations. For example, the processing node 102 may comprise a network platform that may be provisioned or repurposed to operate as a network forwarding device (e.g., switch router). In various implementations, provisioning or repurposing may involve preparing individual processing units 104-1-n of the processing node 102 to perform various processing operations. The embodiments are not limited in this context.

Provisioning of the processing node 102 may generally refer to providing software and/or firmware to enable the processing node 102 to execute operations. For example, provisioning may involve an initial installation of software and/or firmware onto the processing node 102. Provisioning also may involve adding to or replacing existing software and/or firmware previously installed on the processing node 102 after an upgrade, failure, maintenance, reboot and so forth. In various embodiments, provisioning of the processing node 102 may be performed remotely. For example, provisioning may involve downloading software and/or firmware from one or more remote servers over a network. The embodiments are not limited in this context.

In various implementations, provisioning of the processing node 102 may involve loading an OS and/or other application files onto the processing node 102. Examples of an OS include, but are not limited to, the Cisco Internetwork Operating System (IOS), Juniper JUNOS, Microsoft® Windows® OS (e.g., 95, 98, NT, ME, 2000, XP, CE, Longhorn), Apple Macintosh OS, IBM OS, Linux, Unix, Solaris, 3Com Palm OS, and the like. The embodiments are not limited in this context.

In various embodiments, provisioning of the processing node 102 may be performed in accordance with one or more protocols and/or specifications. For example, in various implementations, provisioning may be performed in accordance with an Extensible Firmware Interface (EFI) framework and the EFI Specification (version 1.10. Intel Corporation. 2003). The EFI framework provides a firmware infrastructure that may be used to initialize and configure systems and load OSs or embedded operating environments for computers that use processors compatible with the Intel® Architecture (IA). The EFI framework includes provisions for extending Basic Input/Output System (BIOS) functionality beyond that provided by the BIOS code stored in a BIOS device (e.g., flash memory). For example, while the BIOS code generally includes a mechanism for discovering a subsequent boot environment for 32-bit IA (IA-32) processors, the EFI framework enables firmware, in the form of firmware modules and drivers, to be loaded from a variety of different resources, including primary and secondary flash devices, option Read-Only Memory (ROM), various persistent storage devices (e.g., hard disks), and over computer networks. The embodiments are not limited in this context.

In various implementations, provisioning of the network node 102 may employ a pre-boot execution environment (PXE) protocol according to the PXE Specification (version 2.1 Intel Corporation. 1999). The PXE protocol enables remote booting over a network. PXE remote-boot authentication may utilize Boot Integrity Services (BIS) protocol and/or Trusted Computing Group (TCG) protocol for security capabilities. The network node 102 may issue requests and receive replies, such as Dynamic Host Configuration Protocol (DHCP) requests and replies over a network, and may download information using a file transfer protocol (FTP), such as Trivial FTP (TFTP) or Multicast TFTP (MTFTP), for example. The embodiments are not limited in this context.

The network processing node 102 may comprise an identity 106. In various embodiments, the identity 106 may comprise a Globally-Unique Identification (GUID) according to the EFI standard. The GUID may comprise, for example, a 128-bit value guaranteed to be statistically unique. The identify 106 also may comprise a public key associated with a Trusted Platform Module (TPM) according to the TCG protocol. In various implementations, the identity 106 may be associated with the network processing node 102 and/or with one or more processing units 104-1-n of the processing node 102. In various implementations, the identity 106 may be used to determine a particular type of software and/or firmware to load onto the network processing node 102. The embodiments are not limited in this context.

The network processing node 102 may comprise a boot loader 108. In various embodiments, the boot loader 108 may be implemented as firmware. The boot loader 108 may comprise various firmware components such as software, programs, data, drivers, application program interfaces (APIs), and so forth. The boot loader 108 may be stored in nonvolatile (NV) memory of the processing node 102, such as in bit-masked read-only memory (ROM) or flash memory. In various implementations, storing the boot loader 108 in ROM may preserve flash memory. The NV memory may comprise other types of memory including, for example, programmable ROM (PROM), erasable programmable ROM (EPROM), electrically erasable programmable ROM (EEPROM), or battery backed random-access memory (RAM) such as dynamic RAM (DRAM), Double-Data-Rate DRAM (DDRAM), and/or synchronous DRAM (SDRAM). The embodiments are not limited in this context.

In various implementations, the boot loader 108 may be arranged to enable the network processing node 102 to perform remote repurposing or provisioning. For example, the boot loader 108 may be arranged to connect to a remote server across a network and download appropriate firmware and/or software for installing an OS on network processing units 104-1-n. The embodiments are not limited in this context.

In various implementations, the boot loader 108 may comprise standardized firmware to allow the standardization of the network node 102 (e.g., network platform, motherboard, substrate). For example, providing a standardized boot loader 108 may allow a hardware manufacturer to deliver a standardized network platform to a customer for remote provisioning at the customer site. In this way, the customer may provision the platform with a proprietary OS without divulging the OS or associated boot code to the manufacture. The embodiments are not limited in this context.

In various implementations, a vendor may purchase a standardized network platform from a hardware manufacture and then sell the standardized platform to a customer as part of an overall system. A vendor may comprise an original equipment manufacturer (OEM), an original design manufacturer (ODM), an independent software vendor (ISV), an independent hardware vendor (IHV), an independent BOIS vendor (IBV), and so forth. The embodiments are not limited in this context.

For example, an OEM may sell a network forwarding device (e.g., switch, router) to a customer. The network forwarding device may include a standardized network platform (e.g., motherboard) including the standardized boot loader 108 of a hardware manufacturer. The OEM may purchase the standardized network platform from the hardware manufacturer and direct the hardware manufacture to deliver the standardized network platform directly to the customer. Upon installation at the customer site, the network platform may use the boot loader 108 to connect to a remote server associated with the OEM and download a proprietary OS of the OEM across a network. When provisioned with the OS of the OEM, the network platform may operate as a network forwarding device of the OEM. The embodiments are not limited in this context.

The network processing node 102 may comprise a certificate 110. In various embodiments, the certificate 106 may comprise a public key associated with a certifying authority (CA). The CA may comprise, for example, an OEM, an ODM, an ISV, an IHV, an IBV, or the like. The certificate 106 may comprise a name or other information identifying the CA, an expiration date, a serial number, and other information. The certificate 106 may be used, for example, to encrypt data, decrypt data, and/or create a digital signature for authenticating data sent from the processing node 102. In various implementations, the certificate 106 may used to authenticate the network processing node 102 during remote provisioning. The embodiments are not limited in this context.

The system 100 may comprise one or more provisioning nodes, such as provisioning node 112, to remotely repurpose or provision the network processing node 102. For example, the provisioning node 112 may be arranged to provide the processing node 102 with resources such as software and/or firmware across a network. In various implementations, the provisioning node 112 may be associated with a vendor, such as an OEM. During remote provisioning, the provisioning node 112 may confirm that the processing node 102 includes a certificate 110 associated with the OEM. The embodiments are not limited in this context.

In various embodiments, the provisioning node 106 may comprise one or more servers, such as a proxy server 114 and a boot server 116. The proxy server 114 and the boot server 116 may comprise PXE servers in an EFI environment, for example. In various implementations, the proxy server 110 may be arranged to redirect the network processing node 102 to the boot server 116, and the boot server 116 may be arranged to provide software and/or firmware to the processing node 102. The embodiments are not limited in this context.

In various embodiments, the boot server 116 may comprise provisioning information 118 to repurpose or provision the network processing node 102. The provisioning information 118 generally may comprise various types of information and files (e.g., executables, credentials) pertaining to one or more boot services hosted by the boot server 116. In various implementations, the provisioning information 118 may be stored in memory within the boot server 116 and/or may be stored on a network attached storage (NAS) appliance. The embodiments are not limited in this context.

The provisioning information 118 may comprise one or more boot images, such as boot image 120. In one embodiment, the boot image 120 may be implemented as a Portable Executable/Common Object File Format (PE/COFF) image. The boot image 120 may comprise one or more files to load and/or install an OS such as an OS file and/or an executable file (e.g., EFI application, OS loader, OS installer). In various implementations, the boot image 120 may comprise a pre-compiled set of OS executables, drivers, and data particular to a given platform configuration. The embodiments are not limited in this context.

In various embodiments, the provisioning node 112 may comprise a configuration profile database 122. The configuration profile database 112 may comprise, or be implemented as, any computer-readable storage media capable of storing data, including both volatile and non-volatile memory. Examples of storage media include flash memory, ROM, RAM, DRAM, DDRAM, SDRAM, PROM, EPROM, EEPROM, content addressable memory (CAM), polymer memory (e.g., ferroelectric polymer memory, ovonic memory, phase change or ferroelectric memory), silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information. The configuration profile database 122 may contain various combinations of machine-readable storage devices through various controllers, which are accessible by a processor and which are capable of storing a combination of computer program instructions and data. The embodiments are not limited in this context.

In various embodiments, the configuration profile database 122 may comprise a data structure (e.g., array, file, table, record) for associating provisioning information 118 of a boot server 116 with a particular network processing node 102. For example, the configuration profile database 122 may comprise an array that associates the identity 106 (e.g., GUID) of particular network processing node 102 with certain provisioning information 118. In various implementations, the boot server 116 may be arranged to access the profile configuration database 122 and provide platform-specific provisioning information when a particular GUID is present within the profile configuration database 122. If a particular GUID is not present within the profile configuration database 122, the boot server 116 may be arranged to provide generic provisioning information. The embodiments are not limited in this context.

In various implementations, the network processing node 102 and the provisioning node 112 may send and receive communications, such as communications 124-138, for example. The communications 124-138 generally may comprise one or more types of information communicated through one or more types of communication media. Examples of communication media may include wired communication media, wireless communication media, or a combination of both, as desired for a given implementation. The communications media also may include one or more networks (e.g., WAN), intermediate nodes, routers, switches, hubs, adapters, sockets, and wired or wireless data pathways, to direct and/or deliver data. The embodiments are not limited in this context.

As shown in FIG. 1, the network processing node 102 may send a request 124 to the provisioning node 112. In various embodiments, the request 124 may comprise a DHCP request and may include one or more PXE tags that identify the request 124 as coming from a PXE-enabled computing platform. In various implementations, the request 124 may be received at the proxy server 114 of the provisioning node 112. The embodiments are not limited in this context.

The provisioning node 112 may send a reply 126 to the network processing node 102. In various embodiments, the reply 126 may comprise a DHCP acknowledgment sent from the proxy server 114 of the provisioning node 112. The reply 126 may include a list of one or more available boot servers, such as boot server 116. In various implementations, if the acknowledgment 126 is not received by the networking processing node 102 within a predetermined timeout period, the network processing node 102 may implement various error processing and/or recovery techniques before resending a request. The embodiments are not limited in this context.

The processing node 102 may send a request 128 to the provisioning node 112. In various embodiments, the request 128 may comprise a PXE Boot Server Discovery request and may be received at the boot server 116 of the provisioning node 112. In various implementations, the request 128 may comprise the identify 106 (e.g., GUID) of the processing node 102 and may be authenticated using the certificate 110 (e.g., public key) of the processing node 102. The embodiments are not limited in this context.

The provision node 112 may send a reply 130 to the network processing node 102. In various embodiments, the reply 130 may comprise a Boot Server acknowledgment sent from the boot server 116. The reply 130 may include a file name for an available boot image, such as boot image 120. In various implementations, the boot server 116 may determine whether the identity 106 (e.g., GUID) of the network processing node 102 is stored in the configuration profile database 122. If the identity 106 is present, the reply 130 may comprise a file name for a platform-specific boot image. If the identity 106 is not present in the configuration profile database 122, the reply 130 may comprise a file name for a generic boot image. The embodiments are not limited in this context.

The processing node 102 may send a request 132 to the provisioning node 112. In various embodiments, the request 132 may comprise a PXE Download Request and may be received at the boot server 116. The request 132 may include a file transfer request to download a particular boot image identified by the boot server 116. The embodiments are not limited in this context.

The provisioning node 112 may send a boot agent 134 to the processing node 102. In various embodiments, the boot agent 134 may comprise an EFI application (e.g., OS loader, OS installer) including a particular boot image, such as boot image 120. The boot agent 134 may be downloaded using TFTP or MTFTP, for example. The embodiments are not limited in this context.

The network processing node 102 may send a request 136 to the provisioning node 112. In various embodiments, the request 136 may comprise a DHCP request. The request 136 may include a request for a credentials associated with the boot agent 134. The embodiments are not limited in this context.

The provision node 112 may send a reply 138 to the network processing node 102. In various embodiments, the reply 138 may comprise a DHCP acknowledgement sent from the boot server 116. The reply 138 may comprise credentials, such as a digital signature created with a private key, for example. The embodiments are not limited in this context.

In various embodiments, the processing node 102 may only accept an authenticated boot agent 134 to guard against rogue boot servers. In various implementations, the processing node 102 may authenticate the credentials of a boot agent 134 with the certificate 110. For example, the processing node 102 may use a public key from the certificate 110 to authenticate a signature created at the boot server 116 using a private key. The embodiments are not limited in this context.

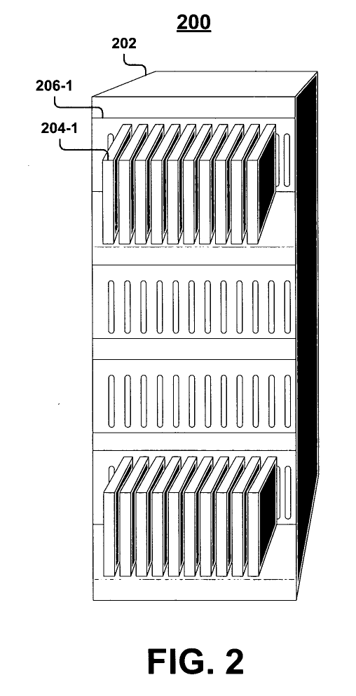

FIG. 2 illustrates one embodiment of a node. FIG. 2 illustrates one embodiment of a network processing node 200. In various embodiments, the processing node 200 may comprise a blade server 202 including multiple network blades. The blade server 202 may be arranged to provide power and communication functions for multiple network blades, such as network blade 204-1. The network blade 204-1 may comprise a modular electronic circuit board containing one or more microprocessors and memory and may occupy a slot in the blade server 202. The embodiments are not limited in this context.

Multiple network blades may be coupled to an interface plane, such as interface plane 206-1, through one or more mating connectors. The interface plane 206-1 may comprise a backplane or mid-plane, for example, and may include respective mating connectors that provide power and communication signals to the network blades. The interface plane 206-1 may be coupled to one or more power supplies such as redundant and hot-swappable power planes and conditioning circuitry to enable continued operation in the event of a power supply failure. The embodiments are not limited in this context.

The blade server 202 may communicate over a network through the interface plane 106-1. In various implementations, the interface plane 106-1 may comprise one or more network cards to allow network communication. In general, a network card may include a physical interface comprising a plurality of network port connections (e.g., RJ-45 ports), or may comprise a high-density connector designed to connect to a network device, such as a network switch, hub, or router, for example. The embodiments are not limited in this context.

In various implementations, the processing node 200 comprising a blade server 202 may be remotely repurposed or provisioned to perform as a network forwarding device. Although the described embodiments may be implemented by a processing node 200 comprising a blade server 202, it is to be understood that such embodiments may be implemented by various types of network processing systems and computing platforms.

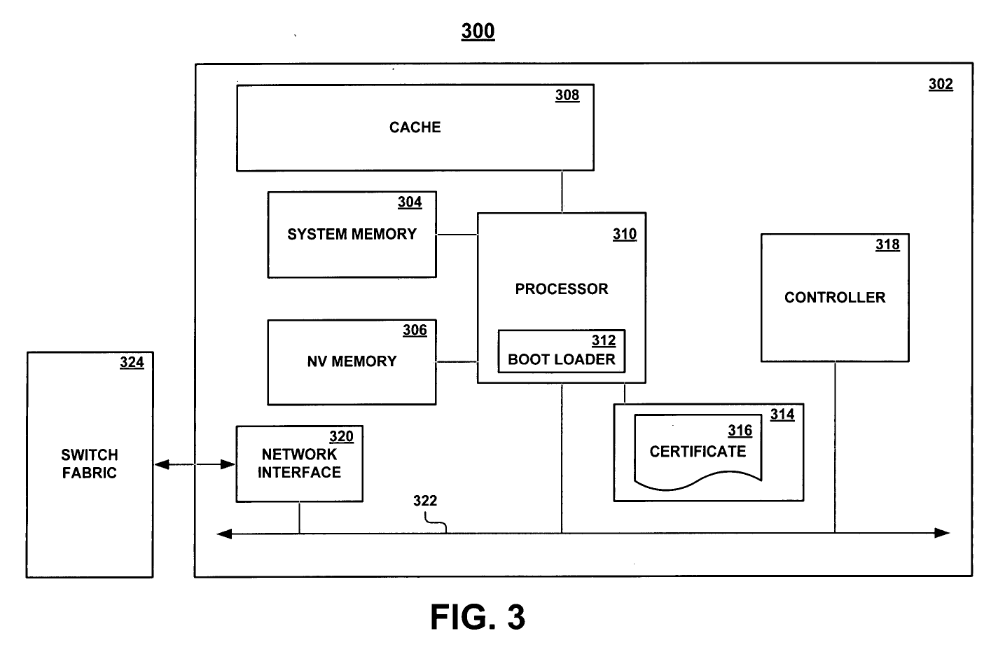

FIG. 3 illustrates one embodiment of a system. FIG. 3 illustrates a block diagram of a network processing system 300. As shown, the network processing system 300 may comprise a network platform 302. In various embodiments, the network platform 302 may comprise components such as integrated circuits (ICs) and memory devices mounted to a main circuit board (e.g., motherboard) and coupled through internal connections (e.g., buses). Examples of memory devices include flash memory, ROM, RAM, DRAM, DDRAM, SDRAM, PROM, EPROM, EEPROM, CAM, polymer memory, SONOS, disk memory, card memory, or any other type of media suitable for storing information. The embodiments are not limited in this context.

As shown in FIG. 3, the network platform 302 may comprise a system memory 304 (e.g., SDRAM), a nonvolatile (NV) memory 306 (e.g., flash memory), and cache 308 (e.g., DRAM/SDRAM battery backed post-write cache). In some embodiments, the network platform 302 may comprise additional memory for extending storage such as optional DRAM and/or optional CAM, for example. The embodiments are not limited in this context.

The system memory 304, the NV memory 306, and the cache 308 may be coupled to a processor 310 (e.g., network processor). The processor 310 may comprise a boot loader 312. In various embodiments, the boot loader 312 may be implemented within memory, such as within dedicated ROM and/or in flash memory. The network platform 302 also may comprise a secure storage 314 for a certificate 316. The secure storage 314 may be implemented as any type of tamper-proof memory. The embodiments are not limited in this context.

The network processor may comprise a controller 318 (e.g., network controller) and a network interface 320 (e.g., bridge) coupled to a bus 322. The network interface 320 may comprises any suitable interface capable of coupling the processor 310 to one or more networks and/or network devices. In various embodiments, the network interface 320 may comprise one or more interfaces such as, for example, a transmit interface, a receive interface, a Peripheral Component Interface (PCI), a Media and Switch Fabric (MSF) Interface, a System Packet Interface (SPI), a Common Switch Interface (CSI), a Small Computer System Interface (SCSI), an Internet Exchange (IE) interface, a Fabric Interface Chip (FIC), network interface card (NIC), an input/output (I/O) adapter, a line card, a port, or any other suitable interface. The embodiments are not limited in this context.

In various implementations, the communication interface 320 may be arranged to connect the network platform 302 to one or more physical layer devices and/or a switch fabric 324. The processing platform 302 may provide an interface between a network and the switch fabric 324 and may perform various processing on the data transmitted and received across the switch fabric 324. The embodiments are not limited in this context.

Operations for the above systems, nodes, apparatus, elements, and/or subsystems may be further described with reference to the following figures and accompanying examples. Some of the figures may include programming logic. Although such figures presented herein may include a particular programming logic, it can be appreciated that the programming logic merely provides an example of how the general functionality as described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

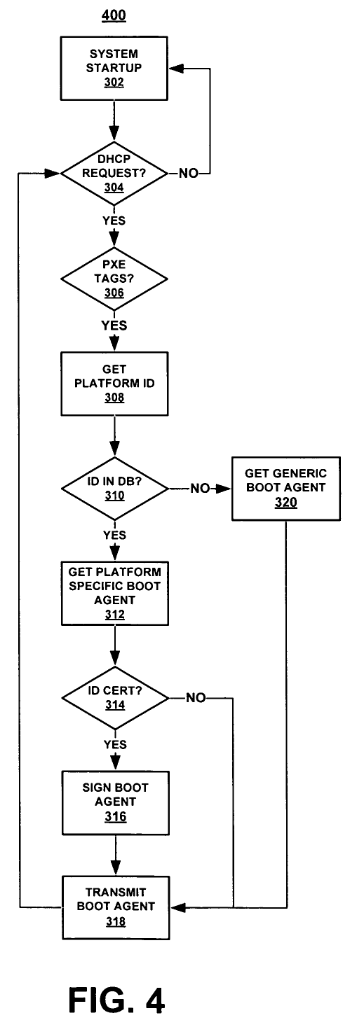

FIG. 4 illustrates one embodiment of programming logic. FIG. 4 illustrates a logic diagram of programming logic 400. In various implementations, the programming logic 400 may be performed by one or more elements of a system, such as by the provisioning node 112 of system 100, for example. It is to be understood, however, that the described embodiments may be implemented by various types of network processing systems and computing platforms.

In various embodiments, the programming logic 400 may comprise a system startup (block 402), such as such as restarting a boot server. The system may remain in an initial state until a DHCP request is received (block 404). If a received DHCP request includes PXE option tags (block 406), a platform identification (ID), such as a GUID, may be obtained (block 408). If the platform ID is present within a database (DB), such as a configuration profile database (block 410), a platform-specific boot agent may be obtained (block 412). The boot agent may comprise a platform-specific boot image, for example.

If the system ID has a certificate (block 414), the boot agent may be signed with a private key (block 416) and transmitted to the platform (block 418). If the platform ID is not present within a DB, such as a configuration profile database (block 310), a generic boot agent may be obtained (block 420) and transmitted to the platform (block 318).

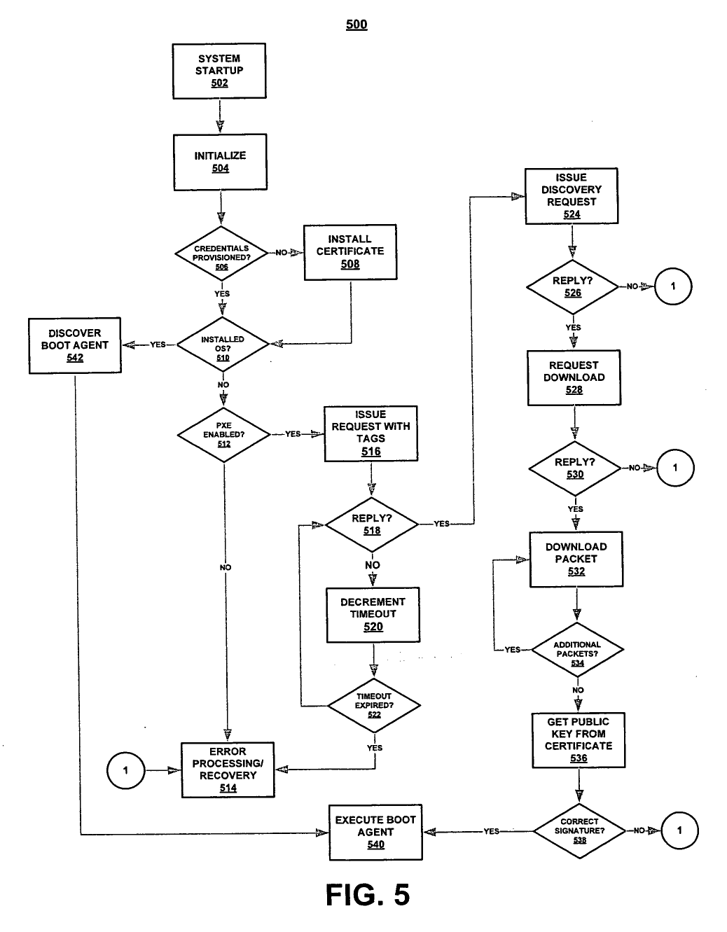

FIG. 5 illustrates one embodiment of programming logic. FIG. 5 illustrates a logic diagram of programming logic 500. In various implementations, the programming logic 500 may be performed by one or more elements of system 100, the network processing node 200, and/or the network processing system 300. It is to be understood, however, that the described embodiments may be implemented by various types of network processing systems and computing platforms.

In various embodiments, the programming logic 500 may comprise a system startup (block 502), such as such as restarting a network platform. The system may be initialized (block 504), such as by initializing memory, networking inputs and outputs (I/O), and other system components (block 504).

If system credentials are not provisioned (block 506), a certificate may be installed (block 508) using a local console or Web interface, for example. If system credentials are provisioned (block 506) and an OS is not locally installed OS (block 510), a determination is made whether the platform is PXE firmware enabled (block 512). If the platform is not PXE firmware enabled, error processing and/or recovery operations may be performed (block 514).

If the platform is PXE firmware enabled (block 512), the platform may issue a DHCP request with PXE option tags (block 516). If a DHCP reply (e.g., acknowledgment) is not received (block 518), a timeout is decremented (block 520). If the timeout expires (block 522), error processing and/or recovery operations may be performed (block 514).

If a DHCP reply is received (block 518), the platform may issue a discovery request (block 524). If a reply (e.g., acknowledgment) to the discovery request is received (block 526), a download request may be issued (block 528). If a reply is not received (block 526), error processing and/or recovery operations may be performed (block 514).

If a reply (e.g., acknowledgment) to the download request is received (block 530), the platform may download a packet (block 532). If a reply is not received (block 530), error processing and/or recovery operations may be performed (block 514).

If there are no additional packets to download (block 534), the platform may get a public key from a certificate (block 536). If the public key indicates a correct signature, such as an authentic boot image (block 538), a boot agent (e.g., OS loader, OS installer) may be executed (block 540). If a signature is not correct, error processing and/or recovery operations may be performed (block 514).

If a locally installed OS is present on the platform (block 510), a local boot agent may be discovered (block 542) and executed (540).

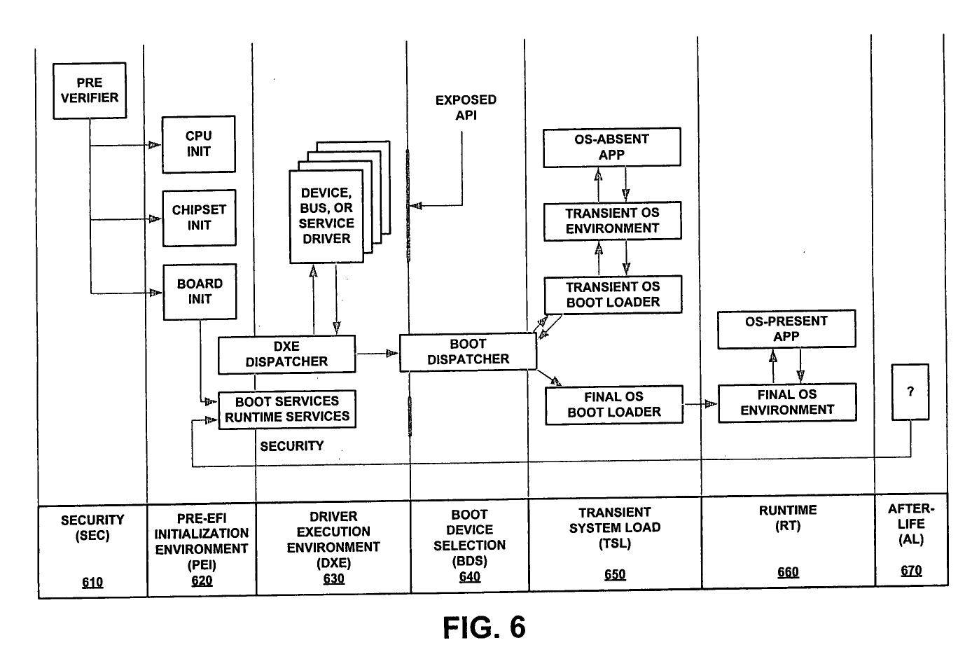

FIG. 6 illustrates one embodiment of a framework. FIG. 6 illustrates a sequence/architecture diagram of framework 600. Framework 600 may comprise various operations and corresponding architecture to initialize a system and provide services through a series of phases. Each phase may be characterized by available resources, rules by which code in the phase must abide, and/or the results of the phase.

As shown, the framework 600 comprises several phases, including a Security (SEC) phase 610, a pre-EFI Initialization Environment (PEI) phase 620, a Driver Execution Environment (DXE) phase 630, a Boot Device Selection (BDS) phase 640, a Transient System Load (TSL) phase 650, and a runtime (RT) phase 660, and an After-Life (AL) phase 670. In various implementations, framework 600 may provide the run-time environment for an OS and a platform.

The Security (SEC) phase 610 may be arranged to pre-verify code to ensure the integrity of the chosen platform firmware image. The Security (SEC) phase 610 may begin with power-on and may comprise operations required to find and authenticate the PEI components before launch. The SEC phase 610 may ensure that code executed by a processor is authentic and that the code has sufficient resources to determine the authenticity of subsequent code.

The PEI phase 620 may be arranged to provide a standardized method of loading and invoking specific initial configuration routines. The PEI phase 620 may be responsible for initialization of platform components, including a CPU, chipset, and board (e.g., motherboard). Typical operations performed during the PEI phase 620 may include power-on self test (POST) operations, and discovery of platform resources. In particular, the PEI phase 620 may discover memory and prepare a resource map to hand off to the DXE phase 630.

The DXE phase 630 may be arranged to perform a majority of system initialization. The DXE phase 630 may employ several components, including a DXE dispatcher for discovering and executing a device, bus, or service driver. The components may work together to initialize a platform and provide the services required to boot an operating system such as boot services and runtime services.

The BDS phase 640 may be arranged to locate and loads various applications that execute in the pre-boot services environment. Such applications might represent a traditional OS boot loader, or extended services that might run instead of, or prior to loading the final OS. Such extended pre-boot services might include setup configuration, extended diagnostics, flash update support, OEM value-adds, or the OS boot code. A boot dispatcher may be employed during the BDS phase 640 to enable selection of a boot target, e.g., an OS to be booted by the system.

The TSL phase 650 may be arranged to provide service interfaces to OS loaders before the platform is controlled by the OS. During the TSL phase 650, a final OS Boot loader may be employed to load a selected OS. In various implementations, the TSL phase 650 may support the programming logic 500 illustrated in FIG. 5.

The RT phase 660 may be arranged to provide certain EFI drivers during OS execution to support the OS as required. The Afterlife (AL) phase 670 may be arranged to allow platform firmware to execute after the OS in the case of voluntary or involuntary termination of the OS.

In various implementations, the described embodiments may be implemented by a processing systems such as the Intel® IXP2400 network processor, the Intel® IXP2800 network processor, the Intel® Software Development Kit (SDK), the Intel® Internet Exchange Architecture (IXA), and/or any multi-core architecture.

It is to be understood that the described embodiments are not limited in application and may be applicable to various devices, systems, and/or operations involving packet processing. For example, the described embodiments may be implemented in a switch on a high speed backplane fabric in some implementations.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although a system may be illustrated using a particular communications media by way of example, it may be appreciated that the principles and techniques discussed herein may be implemented using any type of communication media and accompanying technology. For example, a system may be implemented as a wired communication system, a wireless communication system, or a combination of both.

When implemented as a wireless system, for example, a system may include one or more wireless nodes arranged to communicate information over one or more types of wireless communication media. An example of a wireless communication media may include portions of a wireless spectrum, such as the radio-frequency (RF) spectrum and so forth. The wireless nodes may include components and interfaces suitable for communicating information signals over the designated wireless spectrum, such as one or more antennas, wireless transmitters/receivers (“transceivers”), amplifiers, filters, control logic, and so forth. As used herein, the term “transceiver” may be used in a very general sense to include a transmitter, a receiver, or a combination of both. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

When implemented as a wired system, for example, a system may include one or more nodes arranged to communicate information over one or more wired communications media. Examples of wired communications media may include a wire, cable, metal leads, printed circuit board (PCB), backplane, switch fabric, semiconductor material, twisted-pair wire, co-axial cable, fiber optics, and so forth. The embodiments are not limited in this context.

In various embodiments, communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an ASIC, PLD, DSP, and so forth. In yet another example, an embodiment may be implemented by any combination of programmed general-purpose computer components and custom hardware components. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a network processing node to receive provisioning information from a provisioning node, the network processing node comprising:
an identity to associate provisioning information with said network processing node;
a boot loader to request provisioning information from said provisioning node; and
a certificate to authenticate said network processing node, wherein said certificate is associated with said provisioning node.

2. The apparatus of claim 1, wherein said provisioning information comprises an application to load an operating system.

3. The apparatus of claim 1, wherein said identity comprises a globally-unique identification.

4. The apparatus of claim 1, wherein said boot loader comprises firmware stored in nonvolatile memory.

5. The apparatus of claim 1, wherein said certificate comprises a public key.

6. A system, comprising:
a switch fabric;
a network platform to couple to said switch fabric, said network platform comprising:
an identity to associate provisioning information with said network platform;
a boot loader to request provisioning information from a provisioning node; and
a certificate to authenticate said network processing node, wherein said certificate is associated with said provisioning node.

7. The system of claim 6, wherein said provisioning information comprises an application to load an operating system.

8. The system of claim 6, wherein said identity comprises a globally-unique identification.

9. The system of claim 6, wherein said boot loader comprises firmware stored in nonvolatile memory.

10. The system of claim 6, wherein said certificate comprises a public key.

11. A method, comprising:
requesting provisioning information from a provisioning node across a network;
providing said provisioning node with an identity to associate provisioning information with a network processing node; and
authenticating said provisioning node with a certificate associated with said provisioning node.

12. The method of claim 11, further comprising receiving provisioning information from said provisioning node.

13. The method of claim 11, wherein said provisioning information comprises an application to load an operating system.

14. The method of claim 11, wherein said identity comprises a globally-unique identification.

15. The method of claim 14, wherein said certificate comprises a public key.

16. An article comprising a machine-readable storage medium containing instructions that if executed enable a system to:
request provisioning information from a provisioning node across a network;
provide said provisioning node with an identity to associate provisioning information with a network processing node; and
authenticate said provisioning node with a certificate associated with said provisioning node.

17. The article of claim 16, further comprising instructions that if executed enable the system to receive provisioning information from said provisioning node.

18. The article of claim 16, wherein said provisioning information comprises an application to load an operating system.

19. The article of claim 16, wherein said identity comprises a globally-unique identification.

20. The article of claim 16, wherein said certificate comprises a public key.
